(19) United States
(12) Patent Application Publication
(10) Pub. No.: US 2024/0179616 A1
(43) Pub. Date: May 30, 2024

(54) METHOD AND APPARATUS FOR RADIO SIGNAL TRANSMISSION AND RECEPTION IN COMMUNICATION SYSTEM

(71) Applicant: ELECTRONICS AND TELECOMMUNICATIONS RESEARCH INSTITUTE, Daejeon (KR)

(72) Inventors: Kap Seok CHANG, Daejeon (KR); Won Cheol Cho, Daejeon (KR); Young Jo Ko, Daejeon (KR)

(21) Appl. No.: 18/523,613

(22) Filed: Nov. 29, 2023

(30) Foreign Application Priority Data
Nov. 29, 2022 (KR) 10-2022-0163519
Nov. 27, 2023 (KR) 10-2023-0166717

(51) Int. Cl. H04W 48/16; H04L 27/20

(52) U.S. Cl. CPC H04W 48/16; H04L 27/20

(57) ABSTRACT

A method of a first communication node may comprise: generating a first intermediate base sequence consisting of M elements based on first, second and third binary sequences, wherein M is a natural number; generating a second intermediate base sequence consisting of M elements by modifying the first intermediate base sequence; generating a base sequence consisting of 2M elements based on distributed concatenation of the first intermediate base sequence and the second intermediate base sequence; mapping modulation symbols generated by modulating the base sequence to 2 (M+1) subcarriers; and transmitting a signal consisting of the mapped modulation symbols to a second communication node.

### CROSS-REFERENCE TO RELATED APPLICATIONS

This application claims priority to Korean Patent Applications No. 10-2022-0163519, filed on Nov. 29, 2022, and No. 10-2023-0166717, filed on Nov. 27, 2023, with the Korean Intellectual Property Office (KIPO), the entire contents of which are hereby incorporated by reference.

### BACKGROUND

### 1. Technical Field

Exemplary embodiments of the present disclosure relate to a radio signal transmission and reception technique, and more specifically, to a radio signal transmission and reception technique in a communication system, which is for improving performance of cell identification operations based on radio signals.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, a terminal acquires time and frequency synchronization to connect to an LTE or NR wireless communication system. Additionally, the terminal estimates a physical cell identity (PCI) using a synchronization signal related to cell identification for identifying a serving cell. Methods for PCI detection may include both coherent and non-coherent detection methods. Among these PCI detection methods, the coherent method may face issues such as low reliability in channel estimation performance and high estimation complexity. Therefore, in general, non-coherent detection methods are widely preferred. In the non-coherent detection method, a phase change during a cross-correlation between a received signal and a known synchronization signal may lead to performance degradation.

### SUMMARY

Exemplary embodiments of the present disclosure are directed to providing a method and an apparatus for transmitting and receiving radio signals in a communication system, which are for improving performance of cell identification operations based on radio signals.

According to a first exemplary embodiment of the present disclosure, a method of a first communication node may comprise: generating a first intermediate base sequence consisting of M elements based on first, second and third binary sequences, wherein M is a natural number; generating a second intermediate base sequence consisting of M elements by modifying the first intermediate base sequence; generating a base sequence consisting of 2M elements based on distributed concatenation of the first intermediate base sequence and the second intermediate base sequence; mapping modulation symbols generated by modulating the base sequence to 2 (M+1) subcarriers; and transmitting a signal consisting of the mapped modulation symbols to a second communication node.

The generating of the first intermediate base sequence may comprise: generating an initial base sequence by performing an element-wise modulo-2 sum operation on the first, second, and third binary sequences; and generating the first intermediate base sequence by performing a binary phase shift keying (BPSK) operation on the initial base sequence.

The first binary sequence may be a first m-sequence with a length of 63, the second binary sequence may be a second m-sequence with a length of 63 obtained by decimating the first binary sequence by 17, and the third binary sequence may be a third m-sequence with a length of 7 obtained by decimating the first binary sequence by 9.

The first binary sequence may be generated based on a first generator polynomial having a maximum degree (n+1) and a first identifier for the first communication node, the second binary sequence may be generated based on a second generator polynomial having a maximum degree (n+1) and the first identifier for the first communication node, the third binary sequence may be generated based on a third generator polynomial having a maximum degree (n/2+1) and the first identifier for the first communication node, and n is a natural number.

The second intermediate base sequence may be a sequence whose polarity is opposite to a polarity of the first intermediate base sequence.

According to a second exemplary embodiment of the present disclosure, a method of a second communication node may comprise: receiving, from a first communication node, a signal consisting of modulation symbols generated by modulating a base sequence associated with a physical cell identity of the first communication node; and obtaining the physical cell identity of the first communication node from the signal using base sequences associated with physical cell identities, wherein each of the base sequences associated with the physical cell identities is generated, for each of the physical cell identities, as 2M elements based on distributed concatenation of a first intermediate base sequence consisting of M elements generated based on first, second, and third binary sequences and a second intermediate base sequence consisting of M elements generated by modifying the first intermediate base sequence, and M is a natural number.

The obtaining of the physical cell identity of the first communication node may comprise: detecting the modulation symbols from the signal; calculating correlation values between the modulation symbols and the base sequences; identifying a physical cell identity of a base sequence with a maximum correlation value; and obtaining the identified physical cell identity as the physical cell identity of the first communication node.

The method may further comprise, when the signal includes a primary synchronization signal (PSS), obtaining the physical cell identity of the first communication node from the signal using the base sequences associated with the physical cell identities; obtaining the PSS from the signal; identifying a physical identity from the obtained PSS; detecting the modulation symbols from the signal; calculating correlation values between the modulation symbols and base sequences associated with the identified physical identity; identifying a physical cell identity of a base sequence with a maximum correlation value; and obtaining the identified physical cell identity as the physical cell identity of the first communication node.

According to a third exemplary embodiment of the present disclosure, a first communication node in a communication system may comprise a processor, wherein the processor may cause the first communication to perform: generating a first intermediate base sequence consisting of M elements based on first, second and third binary sequences, wherein M is a natural number; generating a second intermediate base sequence consisting of M elements by modifying the first intermediate base sequence; generating a base sequence consisting of 2M elements based on distributed concatenation of the first intermediate base sequence and the second intermediate base sequence; mapping modulation symbols generated by modulating the base sequence to 2 (M+1) subcarriers; and transmitting a signal consisting of the mapped modulation symbols to a second communication node.

In the generating of the first intermediate base sequence, the processor may further cause the first communication to perform: generating an initial base sequence by performing an element-wise modulo-2 sum operation on the first, second, and third binary sequences; and generating the first intermediate base sequence by performing a binary phase shift keying (BPSK) operation on the initial base sequence.

The first binary sequence may be a first m-sequence with a length of 63, the second binary sequence may be a second m-sequence with a length of 63 obtained by decimating the first binary sequence by 17, and the third binary sequence may be a third m-sequence with a length of 7 obtained by decimating the first binary sequence by 9.

The first binary sequence may be generated based on a first generator polynomial having a maximum degree (n+1) and a first identifier for the first communication node, the second binary sequence may be generated based on a second generator polynomial having a maximum degree (n+1) and the first identifier for the first communication node, the third binary sequence may be generated based on a third generator polynomial having a maximum degree (n/2+1) and the first identifier for the first communication node, and n is a natural number.

The second intermediate base sequence may be a sequence whose polarity is opposite to a polarity of the first intermediate base sequence.

The synchronization signal for PCI identification according to the present disclosure can use the same frequency resource as the synchronization signal for PCI identification in the NR communication system. Additionally, the synchronization signal for PCI identification according to the present disclosure can increase the number of PCIs compared to the number of PCIs in the NR communication system. Furthermore, the synchronization signal for PCI identification according to the present disclosure can have high PCI detection accuracy in a frequency-selective radio channel environment and hardware impairment conditions.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating an exemplary embodiment of a structure of a radio frame in a communication system.

FIG. 4 is a sequence chart illustrating a first exemplary embodiment of a method for transmitting and receiving signals in a communication system.

FIG. 5 is a conceptual diagram illustrating a first exemplary embodiment of a radio signal structure in a communication system.

FIG. 6 is a conceptual diagram illustrating a second exemplary embodiment of a radio signal structure in a communication system.

FIG. 7 is a conceptual diagram illustrating first and second exemplary embodiments of a radio signal generation method in a communication system.

FIG. 8 is a flowchart illustrating a first exemplary embodiment of a method for detecting cell identification information in a communication system.

FIG. 9 is a graph illustrating maximum normalized cross-correlation values of a cell identification signal for NR and a proposed cell identification signal according to a normalized carrier frequency offset.

FIG. 10A is a graph illustrating performance of a detection error rate of an SSS of TDL-A.

FIG. 10B is a graph illustrating performance of a detection error rate of an SSB of TDL-D.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

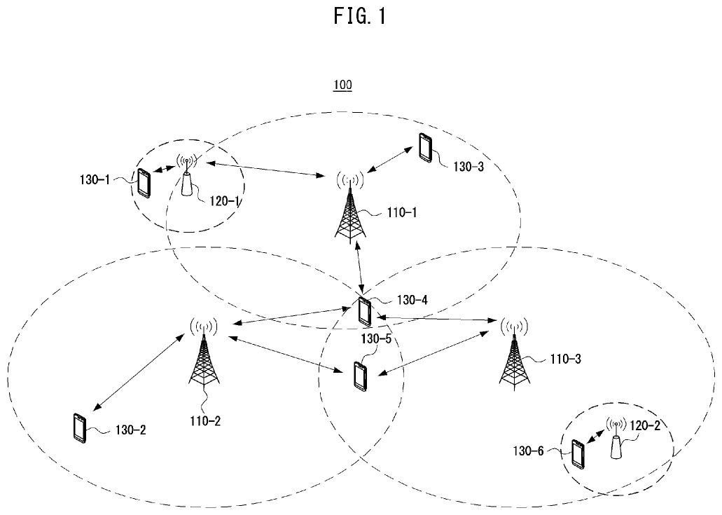

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

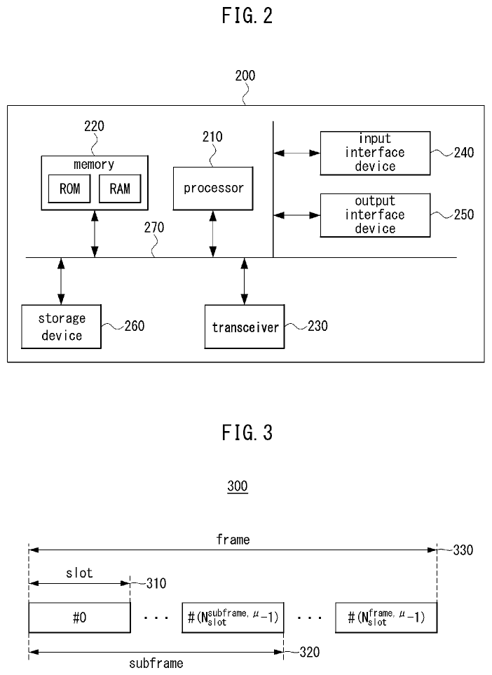

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270. However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like. Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g. a mounted module/device/terminal or an on-board device/terminal, etc.), or the like.

Each of the plurality of communication nodes 110-1, 110-2, 110-3, 120-1, 120-2, 130-1, 130-2, 130-3, 130-4, 130-5, and 130-6 may support cellular communication (e.g. long term evolution (LTE), LTE-Advanced (LTE-A), or the like specified in the 3rd generation partnership project (3GPP)). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink transmission and SC-FDMA-based uplink transmission. In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2.

Hereinafter, radio signal transmission and reception methods in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a receiving node is described, a corresponding transmitting node may perform an operation corresponding to the operation of the receiving node. Conversely, when an operation of a transmitting node is described, a corresponding receiving node may perform an operation corresponding to the operation of the transmitting node.

FIG. 3 is a conceptual diagram illustrating an exemplary embodiment of a structure of a radio frame in a communication system.

Referring to FIG. 3, in the communication system, one radio frame may consist of 10 subframes, and one subframe may consist of 2 time slots. One time slot may have a plurality of symbols in the time domain and may include a plurality of subcarriers in the frequency domain. The plurality of symbols in the time domain may be OFDM symbols. For convenience, an exemplary embodiment of a radio frame structure in the communication system will be described below using an OFDM transmission mode in which the plurality of symbols in the time domain are OFDM symbols as an example. However, this is merely an example for convenience of description, and exemplary embodiments of the radio frame structure in the communication system are not limited thereto. For example, various exemplary embodiments of the radio frame structure in the communication system may be configured to support other transmission modes, such as a single carrier (SC) transmission mode.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 1 is merely an example for convenience of description, and exemplary embodiments of numerologies used in the communication system may not be limited thereto. Each numerology u may correspond to information of a subcarrier spacing (SCS) Δf and a cyclic prefix (CP). The terminal may identify values of the numerology u and CP applied to a downlink bandwidth part or uplink bandwidth part based on higher layer parameters such as ‘subcarrierSpacing’ and ‘cyclicPrefix’.

Time resources in which radio signals are transmitted in a communication system 300 may be represented with a frame 320 comprising one or more (Nₛₗₒₜ^{frame,μ}/Nₛₗₒₜ^{subframe,μ}) subframes, a subframe 320 comprising one or more (Nₛₗₒₜ ^{subframe,∞}) slot slots, and a slot 310 comprising 14 (N_{symb}^{slot}) OFDM symbols. In this case, according to a configured numerology, as the values of N_{symb}^{slot}, Nₛₗₒₜ^{subframe,μ}, and Nₛₗₒₜ^{frame,μ} slot slot , values according to Table 2 below may be used in case of a normal CP, and values according to Table 3 below may be used in case of an extended CP. The OFDM symbols included within one slot may be classified into ‘downlink’, ‘flexible’, or ‘uplink’ by higher layer signaling or a combination of higher layer signaling and L1 signaling.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

In an exemplary embodiment of a communication system, the frame 330 may have a length of 10 ms, and the subframe 320 may have a length of 1 ms. Each frame 330 may be divided into two half-frames having the same length, and the first half-frame (i.e. half-frame 0) may be composed of subframes #0 to #4, and the second half-frame (i.e. half-frame 1) may be composed of subframes #5 to #9. One carrier may include a set of frames for uplink (i.e. uplink frames) and a set of frames for downlink (i.e. downlink frames).

One slot may have 6 (i.e. extended cyclic prefix (CP) case) or 7 (i.e. normal CP case) OFDM symbols. A time-frequency region defined by one slot may be referred to as a resource block (RB). When one slot has 7 OFDM symbols, one subframe may have 14 OFDM symbols (i.e. l=0, 1, 2, . . . , 13).

The subframe may be divided into a control region and a data region. A physical downlink control channel (PDCCH) may be allocated to the control region. A physical downlink shared channel (PDSCH) may be allocated to the data region. Some of the subframes may be special subframes. The special subframe may include a downlink pilot time slot (DwPTS), a guard period (GP), and an uplink pilot time slot (UpPTS). The DwPTS may be used for time and frequency synchronization estimation and cell search of the terminal. The GP may be a period for avoiding interferences caused by multipath delays of downlink signals.

Meanwhile, a terminal may acquire time and frequency synchronization to the LTE or NR wireless communication system. Additionally, the terminal may estimate a physical cell identity (PCI) using a synchronization signal related to cell identification to identify a serving cell. To identify each cell, different cells may have different PCIs. Information on a PCI may be transmitted in a related synchronization signal.

The LTE-related synchronization signal used to PCI detection may be based on a binary sequence. In the LTE-related synchronization signal, the cross-correlation characteristics of a binary sequence-based synchronization signal including a PCI of a serving cell and a binary sequence-based synchronization signal including a PCI of an adjacent cell may not be excellent. Additionally, the cross-correlation characteristics of all possible pairs of different binary sequence-based synchronization signals may have very high variability. This may make cell planning difficult. Additionally, the number of distinguishable PCIs may be only 504.

Meanwhile, a synchronization signal for PCI identification in the NR communication system may also be based on a binary sequence. The NR synchronization signal for PCI identification may have very excellent cross-correlation characteristics of pairs of synchronization signals for PCI identification compared to the LTE synchronization signals. Additionally, the cross-correlation characteristics of all possible pairs of synchronization signals for PCI identification may have very low variability. Accordingly, the synchronization signal for PCI identification in the NR communication system may have an advantage in cell planning. However, the number of distinguishable PCIs may be only 1008.

To solve this difficulty, the NR communication system may generate linearly distinct synchronization signals by cyclically shifting cyclically-distinct sequences. Accordingly, the number of available PCIs may increase. However, cyclically-shifted sequences may not follow the cross-correlation characteristics of a base binary sequence. Therefore, the cross-correlation characteristics of pairs of synchronization signals for PCI identification may deteriorate. Additionally, the cross-correlation characteristics of all possible pairs of synchronization signals for PCI identification may have very high variability.

Meanwhile, PCI detection methods may include a coherent detection method and a non-coherent detection method. Here, the coherent detection method may be a method of detecting a PCI through cross-correlation with a compensated received signal after estimating a radio channel. The coherent detection method may solve phase distortion and frequency-selectivity problems caused by fading. On the other hand, the non-coherent detection method may be a method of detecting a PCI through cross-correlation with a received signal itself without radio channel estimation and compensation.

Among these PCI detection methods, the coherent detection method may have problems such as low reliability of channel estimation performance and high estimation complexity. Accordingly, in general, the non-coherent detection method may be widely used. In the non-coherent detection method, a phase change when taking a cross-correlation between a received signal and a known synchronization signal may cause performance degradation.

An example of such the phase change may be a phase distortion due to a frequency-selectivity of the radio channel. Other examples of the phase change may be a phase noise that randomly affects each time sample and a phase distortion caused by hardware impairment such as a carrier frequency offset (CFO). A new synchronization signal for PCI identification may need to solve the above-described problems. The new synchronization signal for PCI identification that can meet these needs may need to use the same frequency resource as the frequency resource of the synchronization signal for PCI identification in the NR communication system. Additionally, the new synchronization signal for PCI identification may need to increase the number of PCIs compared to the number of PCIs in the NR communication system. Furthermore, the new synchronization signal for PCI identification may need to have high PCI detection accuracy in a frequency-selective radio channel environment and hardware impairment conditions.

The present disclosure describes a proposed signal in the frequency domain by employing orthogonal frequency division multiplexing (OFDM) as a transmission mode, but is not limited thereto. The present disclosure may be applied to a signal in the time domain by employing a single carrier (SC) transmission mode, and may be applied to signals in all other possible transmission modes.

In an exemplary embodiment of the communication system, a synchronization signal may be configured based on one or more sequences. The one or more sequences constituting the synchronization signal may be arranged in the frame 330, subframe 320, slot 310, or OFDM symbol constituting the slot 310 in the time domain. Meanwhile, the one or more sequences constituting the synchronization signal may be modulated and mapped to a plurality of subcarriers in the frequency domain. In an exemplary embodiment of the communication system, the one or more sequences constituting the synchronization signal may correspond to one or more binary sequences or complex sequences.

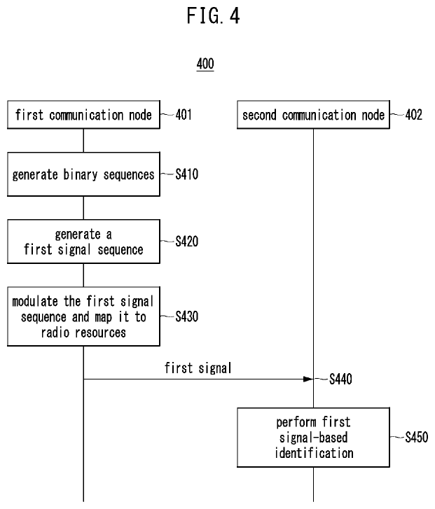

FIG. 4 is a sequence chart illustrating a first exemplary embodiment of a method for transmitting and receiving signals in a communication system.

Referring to FIG. 4, a communication system 400 may include a plurality of communication nodes. For example, the communication system 400 may include at least a first communication node 401 and a second communication node 402. The first communication node 401 may be the same as or similar to a node operating a cell that transmits the synchronization signal described with reference to FIG. 3. The second communication node 402 may be the same as or similar to a receiving node that receives the synchronization signal described with reference to FIG. 3. Hereinafter, in describing an exemplary embodiment of a method for transmitting and receiving signals in the communication system with reference to FIG. 4, contents redundant with those described with reference to FIGS. 1 to 3 may be omitted.

In an exemplary embodiment of the communication system 400, the first communication node 401 may correspond to a cell, base station, network, or the like. The first communication node 401 may transmit a first signal including identification information to be used by users (e.g. UEs, terminals, etc.) within a coverage of the first communication node 401 to identify the first communication node 401. For example, the first communication node 401 may be identified by first identification information. The first identification information may correspond to a physical cell identity (PCI). Alternatively, the first identification information may be information on the PCI. The first identification information may be generated based on the PCI. The first signal including the first identification information may correspond to a synchronization signal. The first signal may include a primary synchronization signal (PSS) and a secondary synchronization signal (SSS). However, this is merely an example for convenience of description, and the first exemplary embodiment of the method for transmitting and receiving signals in the communication system 400 is not limited thereto. The SSS of the first signal may be composed of one or more sequences (hereinafter, one or more first signal sequences). The second communication node 402 may receive the first signal transmitted from the first communication node 401. The second communication node 402 may identify the first communication node 401 based on the received first signal.

Specifically, the first communication node 401 may generate one or more binary sequences (S410). The one or more binary sequences may correspond to pseudo random noise (PN) sequences. The PN sequence may be referred to as an ‘m-sequence’. The first communication node 401 may generate one or more first signal sequences based on the one or more binary sequences (S420).

The first communication node 401 may modulate the one or more first signal sequences generated in the step S420 and allocate (or map) them to radio resources (S430). For example, the first communication node 401 may modulate the one or more generated first signal sequences to generate one or more modulation symbols. The first communication node 401 may allocate the one or more generated modulation symbols in time resources and/or frequency resources.

The first communication node 401 may transmit to the second communication node 402 a first signal including a PSS and an SSS composed of the one or more first signal sequences modulated and mapped to radio resources (S440). In other words, the first communication node 401 may transmit the first signal including the PSS and the SSS composed of one or more modulation symbols obtained by modulating the one or more first signal sequences to the second communication node 402.

The second communication node 402 may receive the first signal transmitted from the first communication node 401 (S440). The second communication node may perform an identification operation for the first communication node 401 based on the first signal received in the step S440 (S450). The identification in the step S450 may include, for example, cell identification.

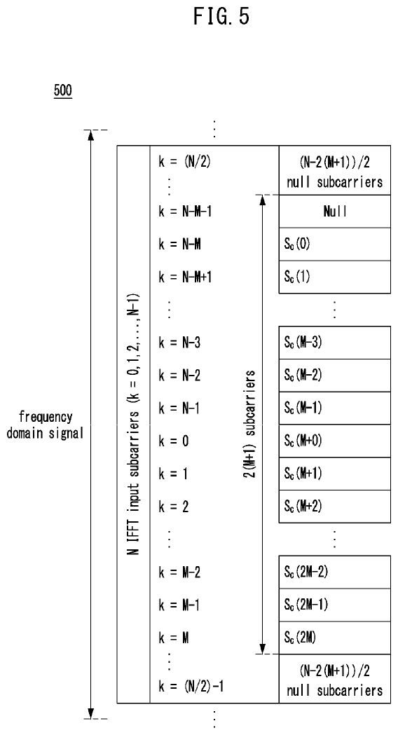

FIG. 5 is a conceptual diagram illustrating a first exemplary embodiment of a radio signal structure in a communication system.

Referring to FIG. 5, a communication system may include a plurality of communication nodes. The communication system may be the same as or similar to the communication system 400 described with reference to FIG. 4. Hereinafter, in describing a first exemplary embodiment of a radio signal structure in the communication system with reference to FIG. 5, contents redundant with those described with reference to FIGS. 1 to 4 may be omitted.

A first communication node may generate a radio signal and transmit it to a second communication node. The first communication node may generate one or more radio signals. The first communication node may generate one or more radio signal sequences to generate the one or more radio signals. The first communication node may modulate one or more elements constituting the one or more generated radio signal sequences and map them to one or more subcarriers in the frequency domain.

In an exemplary embodiment of the communication system, when the number of one or more subcarriers to which the one or more radio signal sequences are mapped is a natural number N of 1 or more, an index k of the subcarriers may have a natural number of 0 or more and N−1 or less. In other words, k may be one of 0, 1, . . . , or N−1. The one or more radio signal sequences may be generated based on a predetermined identification index c. Here, the identification index c may correspond to the first identification information described with reference to FIG. 4. Alternatively, the first identification information may be determined based on the identification index c. The one or more radio signal sequences may be expressed, for example, as S_{c}(m). Here, m may be defined as 0≤m≤2M. Here, M may be the length of a base sequence, and c may be a positive integer.

In an exemplary embodiment of the communication system, the first radio signal may correspond to the first signal described with reference to FIG. 4. The first radio signal may correspond to a synchronization signal, SSS, or the like. Alternatively, the first radio signal may correspond to a newly defined signal for cell identification. The first signal may also be referred to as an ‘identification signal’.

In an exemplary embodiment of the communication system, the radio signal sequence S_{c}(m) may be generated based on two binary sequences. The radio signal sequence S_{c}(m) may be composed of 2M elements (e.g. S_{c}(0), S_{c}(1), . . . , and S_{c}(2M)). The radio signal sequence S_{c}(m) may be modulated and mapped to 2(M+1) subcarriers. In this case, one of the 2 (M+1) subcarriers may be configured as a null subcarrier. The radio signal sequence S_{c}(m) may be referred to as a radio signal sequence for NR.

Referring to FIG. 5, in a first radio signal structure 500, the radio signal sequence S_{c}(m) may be modulated and mapped to 2(M+1) subcarriers represented by indices k (k=0, 1, . . . , and N−1). Each of the 2M elements (e.g. S_{c}(0), S_{c}(1), . . . , and S_{c}(2M)) constituting the radio signal sequence S_{c}(m) may be mapped to subcarriers with corresponding indices. Here, 2(M+1) subcarriers to which the radio signal sequence S_{c}(m) is mapped (i.e. N subcarriers to which modulation symbols obtained by modulating the radio signal sequence S_{c}(m) are mapped) may belong to a first subcarrier group. The 2(M+1) subcarriers constituting the first subcarrier group may be adjacent to or spaced apart from each other in the frequency domain. FIG. 5 illustrates a case where at least some of the 2(M+1) subcarriers constituting the first subcarrier group are arranged adjacent to each other, but this is merely an example for convenience of description, and the first exemplary embodiment of the radio signal structure in the communication system may not be limited thereto. For example, the first subcarrier group may be composed of 2(M+1) subcarriers spaced apart from each other. In other words, the first subcarrier group may be composed of N subcarriers that are not adjacent to each other.

One or more null subcarriers may be arranged around (2M+1) subcarriers constituting the first subcarrier group, or between the 2(M+1) subcarriers. A signal may not be carried in null subcarrier(s). In other words, modulation symbol(s) may not be assigned to null subcarrier(s). The null subcarrier may have a value of 0. The null subcarrier may correspond to a gap subcarrier, direct current (DC) subcarrier, or the like. The null subcarrier may be placed to easily identify the respective subcarriers.

In the frequency domain, null subcarrier(s) may be placed before and/or after the first subcarrier group. For example, null subcarrier(s) may be placed at the front end of the subcarrier corresponding to the subcarrier index N−M−1 and/or at the rear end of the subcarrier corresponding to the subcarrier index M. Additionally, one or more null subcarriers may be placed between the 2(M+1) subcarriers constituting the first subcarrier group. For example, null subcarrier(s) may be placed before and/or after one or more centrally located subcarriers (hereinafter referred to as central subcarriers) among the 2(M+1) subcarriers constituting the first subcarrier group. Alternatively, the first subcarrier group may be divided into a plurality of subgroups, each including one or more subcarriers. Null subcarrier(s) may be placed at the front and/or rear end of each subgroup.

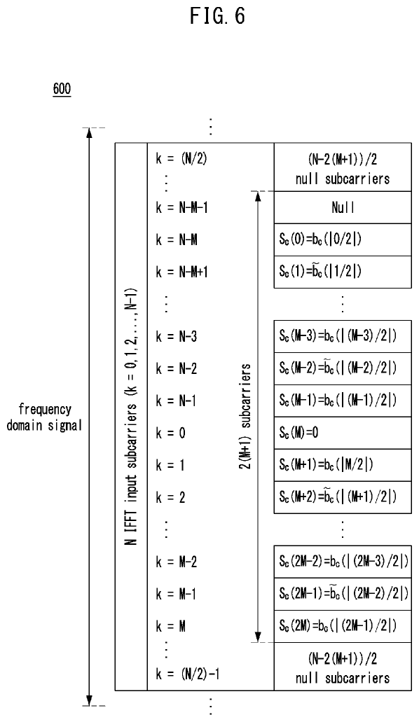

FIG. 6 is a conceptual diagram illustrating a second exemplary embodiment of a radio signal structure in a communication system.

Referring to FIG. 6, a communication system may include a plurality of communication nodes. The communication system may be the same as or similar to the communication system 400 described with reference to FIG. 4. Hereinafter, in describing a second exemplary embodiment of a radio signal structure in the communication system with reference to FIG. 6, contents redundant with those described with reference to FIGS. 1 to 4 may be omitted.

A first communication node may generate a radio signal and transmit it to a second communication node. The first communication node may generate one or more radio signals. The first communication node may generate one or more radio signal sequences to generate the one or more radio signals. The first communication node may modulate one or more elements constituting the one or more generated radio signal sequences and map them to one or more subcarriers in the frequency domain.

In an exemplary embodiment of the communication system, when the number of one or more subcarriers to which the one or more radio signal sequences are mapped is a natural number N of 1 or more, an index k of the subcarriers may have a natural number of 0 or more and N−1 or less. In other words, k may be one of 0, 1, . . . , or N−1. The one or more radio signal sequences may be generated based on a predetermined identification index c. Here, the identification index c may correspond to the first identification information described with reference to FIG. 4. Alternatively, the first identification information may be determined based on the identification index c. The one or more radio signal sequences may be expressed, for example, as S_{c}(m). Here, m may be defined as 0≤m≤2M. Here, M may be the length of a base sequence, and c may be a positive integer.

In an exemplary embodiment of the communication system, the first radio signal may correspond to the first signal described with reference to FIG. 4. The first radio signal may correspond to a synchronization signal, SSS, or the like. Alternatively, the first radio signal may correspond to a newly defined signal for cell identification. The first signal may also be referred to as an ‘identification signal’.

In an exemplary embodiment of the communication system, a radio signal sequence S_{c}(m) may be generated based on three binary sequences. The radio signal sequence S_{c}(m) may be composed of 2M elements (e.g. S_{c}(0), S_{c}(1), . . . , and S_{c}(2M)). The radio signal sequence S_{c}(m) may be modulated and mapped to 2(M+1) subcarriers. In this case, one of the 2 (M+1) subcarriers may be configured as a null subcarrier.

Referring to FIG. 6, in a first radio signal structure 600, the radio signal sequence S_{c}(m) may be modulated and mapped to 2(M+1) subcarriers represented by indices k (k=0, 1, . . . , and N−1). Each of the 2M elements (e.g. S_{c}(0), S_{c}(1), . . . , and S_{c}(2M)) constituting the radio signal sequence S_{c}(m) may be mapped to a subcarrier with a corresponding index. Here, 2(M+1) subcarriers to which the radio signal sequence S_{c}(m) is mapped (i.e. N subcarriers to which modulation symbols obtained by modulating the radio signal sequence S_{c}(m) are mapped) may belong to a first subcarrier group. The 2(M+1) subcarriers constituting the first subcarrier group may be adjacent to or spaced apart from each other in the frequency domain. FIG. 6 illustrates a case where at least some of the 2(M+1) subcarriers constituting the first subcarrier group are arranged adjacent to each other, but this is merely an example for convenience of description, and the second exemplary embodiment of the radio signal structure in the communication system may not be limited thereto. For example, the first subcarrier group may be composed of 2(M+1) subcarriers spaced apart from each other. In other words, the first subcarrier group may be composed of N subcarriers that are not adjacent to each other.

One or more null subcarriers may be arranged around (2M+1) subcarriers constituting the first subcarrier group, or between the 2(M+1) subcarriers. A signal may not be carried in null subcarrier(s). In other words, modulation symbol(s) may not be assigned to null subcarrier(s). The null subcarrier may have a value of 0. The null subcarrier may correspond to a gap subcarrier, direct current (DC) subcarrier, or the like. The null subcarrier may be placed to easily identify the respective subcarriers.

In the frequency domain, null subcarrier(s) may be placed before and/or after the first subcarrier group. For example, null subcarrier(s) may be placed at the front end of the subcarrier corresponding to the subcarrier index N−M−1 and/or at the rear end of the subcarrier corresponding to the subcarrier index M. Additionally, one or more null subcarriers may be placed between the 2(M+1) subcarriers constituting the first subcarrier group. For example, null subcarrier(s) may be placed before and/or after one or more centrally located subcarriers (hereinafter referred to as central subcarriers) among the 2(M+1) subcarriers constituting the first subcarrier group. Alternatively, the first subcarrier group may be divided into a plurality of subgroups, each including one or more subcarriers. Null subcarrier(s) may be placed at the front and/or rear end of each subgroup.

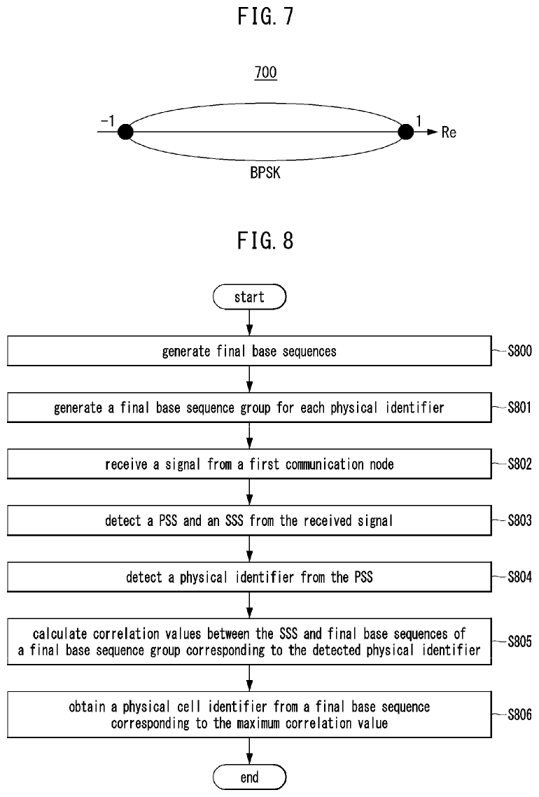

FIG. 7 is a conceptual diagram illustrating first and second exemplary embodiments of a radio signal generation method in a communication system.

Referring to FIG. 7, a communication system may include a plurality of communication nodes. The communication system may be the same as or similar to the communication system 400 described with reference to FIG. 4. In the communication system, a radio signal may have the same or similar structure as the first radio signal structure 500 described with reference to FIG. 5 or the second radio signal structure 600 described with reference to FIG. 6. Hereinafter, in describing the first and second exemplary embodiments of the radio signal generation method with reference to FIG. 7, contents redundant with those described with reference to FIGS. 1 to 6 may be omitted.

### First Exemplary Embodiment of Radio Signal Generation Method

In an exemplary embodiment of the communication system, a first communication node may generate a radio signal according to a first exemplary embodiment of the radio signal generation method. The first exemplary embodiment of the radio signal generation method may be referred to as ‘Binary Phase Shift Keying (BPSK) scheme’. The first exemplary embodiment of the radio signal generation method may be referred to as ‘random BPSK scheme’.

In the first exemplary embodiment of the radio signal generation method, a first radio signal may be generated based on one or more base sequences. The one or more base sequences may be generated based on one or more binary sequences. In other words, the one or more base sequences may correspond to a result of transforming the one or more binary sequences according to the first exemplary embodiment of the radio signal generation method. For example, the one or more binary sequences may correspond to PN sequence(s) or binary PN sequence(s). Alternatively, the one or more binary sequences may correspond to m-sequence(s). Alternatively, each of the one or more binary sequences may be configured as a Gold sequence generated through an element-wise exclusive-OR (XOR) operation on two different PN sequences.

In an exemplary embodiment of the communication system, a base sequence S_{c}(m) may be generated based on two binary sequences x₀(i) and x₁(i). For example, the base sequence S_{c}(m) may be defined identically or similarly to Equation 1. Here, m is an integer and may be 0, 1, . . . , or 2M. i is an integer and may be 0,1, . . . , or (N−1)−7. Additionally, K is a minimum gap between two m₀ and may be an integer.

$${S}_{c} ( m ) = [ 1 - 2 {x}_{0} ( {[ m + {m}_{0} ]}_{127} ) ] [ 1 - 2 {x}_{1} ( {[ m + {m}_{1} ]}_{127} ) ] \qquad [ Equation 1 ]$$

$$g = ⌊ \frac{c}{3} ⌋ , {g}_{0} = ⌊ g / 112 ⌋ , {g}_{1} = {[ g ]}_{112}$$

$${m}_{0} = K ( 3 {g}_{0} + u ) , {m}_{1} = {g}_{1}$$

$${x}_{0} ( i + 7 ) = {[ {x}_{0} ( i + 4 ) + {x}_{0} ( i ) ]}_{2}$$

$${x}_{1} ( i + 7 ) = {[ {x}_{1} ( i + 7 ) + {x}_{1} ( i ) ]}_{2}$$

$$[ {x}_{0} ( 6 ) {x}_{0} ( 5 ) … {x}_{0} ( 1 ) {x}_{0} ( 0 ) ] = [ 0000001 ]$$

$$[ {x}_{1} ( 6 ) {x}_{1} ( 5 ) … {x}_{1} ( 1 ) {x}_{1} ( 0 ) ] = [ 0000001 ]$$

In Equation 1, [a]b may mean b-modulo operation on a value of a. [W] may mean a highest integer smaller than a real number W. N may mean the number of one or more subcarriers to which the first radio signal is mapped in the frequency domain. For example, in Equation 1, N may be 127. The two first binary sequences x₀(i) and x₁(i) may be defined based on different generator polynomials with a maximum degree of 7. The two first binary sequences x₀(i) and x₁(i) may be determined based on recurrence equations ‘x₀(i+7)=[x₀(i+4)+x₀(i)]₂’ and ‘x₁(i+7)=[x₁(i+7)+x₁(i)]₂’, respectively. A modulo-2 operation in each recurrence equation may be the same as or similar to an XOR operation. For example, the modulo-2 operation in each recurrence equation may correspond to an XOR operation in a linear feedback shift register (LFSR). The identification index c may be determined based on a function ‘c=3g+u’ with g and u as input variables. Here, g may correspond to a cell group identity (CGI), and u may correspond to a physical identity (PID). The numbers shown in Equation 1 are merely examples for convenience of description, and the first exemplary embodiment of the radio signal generation method is not limited thereto.

Ξ may mean the number of distinguishable identification index c values. In other words, the number of values that the identification index c can have may correspond to Ξ=1008, for example. A total of 1008 identification indices may be identified by the base sequence S_{c}(m) generated according to Equation 1. However, this is merely an example for convenience of description, and the first exemplary embodiment of the radio signal generation method is not limited thereto.

Theoretically, the maximum number of distinguishable identification indices based on the base sequence S_{c}(m) may be defined by combinations of all possible cycle shift indices of the two first binary sequences x₀(i) and x₁(i) constituting the base sequence S_{c}(m). Each of the cyclic shift indices m₀ and m₁ associated with the two first binary sequences x₀(i) and X₁(i) may have a total of 127 values. Therefore, theoretically, the maximum number of identification indices that can be distinguished based on the base sequence S_{c}(m) may be 1272-16129. The base sequence S_{c}(m) may have up to 127 cyclically distinguishable sequences.

In an exemplary embodiment of the communication system, the value of the identification index c may be selected between 0 and Ξ−1. If c=19 is selected, it may correspond to a case when g₀=0 and g₁=6 based on Equation 1. This case may correspond to a case when g=3 and u=1. In this case, cyclic shift indices associated with the two first binary sequences x₀(i) and x₁(i) may be calculated as m₀=5 and m₁=6. The base sequence S_{c}(m) may be calculated based on the values of the cyclic shift indices m₀ and m₁ calculated as described above.

In Equation 1, a calculation formula S_{c}(m)=[1−2x₀([m+m₀]₁₂₇)][1−2x₁([m+m₁]₁₂₇)] for calculating the base sequence S_{c}(m) based on the two binary sequences binary sequences x₀(i) and x₁(i) may correspond to a BPSK operation. The base sequence S_{c}(m) may have values of a real number 1 or −1.

FIG. 7 shows the base sequence S_{c}(m) generated based on Equation 1 in the first exemplary embodiment of the radio signal generation method, or an exemplary embodiment 710 of constellation of the first radio signal (hereinafter, basic constellation) generated based on the base sequence S_{c}(m). The first radio signal may be expressed as two constellation points on the basic constellation 710. The two constellation points corresponding to the first radio signal may both have a real number 1 or −1.

### Second Exemplary Embodiment of Radio Signal Generation Method

In an exemplary embodiment of the communication system, a first communication node may generate a radio signal according to a second exemplary embodiment of a radio signal generation method. The second exemplary embodiment of the radio signal generation method may be referred to as ‘BPSK scheme’, identically to the first exemplary embodiment. The second exemplary embodiment of the radio signal generation method may be referred to as ‘random BPSK scheme’, identically to the first exemplary embodiment.

In the second exemplary embodiment of the radio signal generation method, a first radio signal may be generated based on one or more final base sequences. Here, the final base sequence may be a tertiary base sequence. Additionally, the one or more final base sequences may be generated based on one or more intermediate base sequences. Here, the intermediate base sequence may be a secondary base sequence. Alternatively, the intermediate base sequence may be a second intermediate sequence.

Meanwhile, the intermediate base sequences may be generated by one or more initial base sequences. In this case, the initial base sequence may be a primary base sequence. Alternatively, the initial base sequence may be a first intermediate sequence. The initial base sequences may be generated based on one or more binary sequences.

For example, the one or more binary sequences may correspond to PN sequence(s) or binary PN sequence(s). Alternatively, the one or more binary sequences may correspond to m-sequence(s). Alternatively, each of the one or more binary sequences may be configured as a Gold sequence generated through an element-wise XOR operation on two different PN sequences.

In an exemplary embodiment of the communication system, an initial base sequence θ_{c}(m) may be generated based on three binary sequences x₀(i), x₁(i), and x₂(i). For example, the length of each of x₀(i) and x₁(i) may be 63, and the length of x₂(i) may be 7. For example, the initial base sequence θ_{c}(m) may be defined identically or similarly to Equation 2. Here, m is an integer and may be 0, 1, . . . , or 2M. i is an integer and may be 0, 1, . . . , or (N−1)−6. Additionally, K is a minimum gap between two m₀ and may be an integer.

$${θ}_{c} ( m ) = {[ {x}_{0} ( {[ m + {m}_{0} ]}_{63} ) + {x}_{1} ( {[ m + {m}_{1} ]}_{63} ) + {x}_{2} ( {[ m + {m}_{2} ]}_{7} ) ]}_{2} \qquad [ Equation 2 ]$$

$${b}_{c} ( m ) = 1 - 2 {θ}_{c} ( m ) \& {\tilde{b}}_{c ( m )} = - {b}_{c} ( m ) , 0 \leq m < M$$

$${S}_{c} ( m ) = \{ \begin{matrix}{b}_{c} ( ⌊ m / 2 ⌋ ) , & 0 \leq even m < M \\ {\tilde{b}}_{u} ( ⌊ m / 2 ⌋ ) , & 0 \leq odd m < M \\ {b}_{c} ( ⌊ ( m - 1 ) / 2 ⌋ ) , & M < odd m \leq 2 M \\ {\tilde{b}}_{c} ( ⌊ ( m - 1 ) / 2 ⌋ ) , & M < even m \leq 2 M\end{matrix}$$

$$g = ⌊ \frac{c}{3} ⌋ , {g}_{0} = ⌊ g / 336 ⌋ , {g}_{1} = {[ g ]}_{48} , {g}_{2} = ⌊ {[ g ]}_{336} / 48 ⌋$$

$${m}_{0} = K ( 3 {g}_{0} + u ) , {m}_{1} = {g}_{1} , {m}_{2} = {g}_{2}$$

$${x}_{0} ( i + 6 ) = {[ {x}_{0} ( i + 1 ) + {x}_{0} ( i ) ]}_{2}$$

$${x}_{1} ( i + 6 ) = {[ {x}_{0} ( i + 5 ) + {x}_{0} ( i + 2 ) + {x}_{0} ( i + 1 ) + {x}_{0} ( i ) ]}_{2}$$

$${x}_{2} ( i + 3 ) = {[ {x}_{0} ( i + 2 ) + {x}_{0} ( i ) ]}_{2}$$

$$[ {x}_{0} ( 5 ) {x}_{0} ( 4 ) {x}_{0} ( 3 ) {x}_{0} ( 2 ) {x}_{0} ( 1 ) {x}_{0} ( 0 ) ] = [ 000001 ]$$

$$[ {x}_{1} ( 5 ) {x}_{1} ( 4 ) {x}_{1} ( 3 ) {x}_{1} ( 2 ) {x}_{1} ( 1 ) {x}_{1} ( 0 ) ] = [ 101001 ]$$

$$[ {x}_{2} ( 2 ) {x}_{2} ( 1 ) {x}_{2} ( 0 ) ] = [ 001 ]$$

In Equation 1, [a]b may mean b-modulo operation on a value of a. [W] may mean a highest integer smaller than a real number W. N may mean the number of one or more subcarriers to which the first radio signal is mapped in the frequency domain. For example, in Equation 1, N may be 127. The two binary sequences x₀(i) and x₁(i) may be defined based on different generator polynomials with a maximum degree of 6. The one binary sequences x₂(i) may be defined based on a generator polynomial with a maximum degree of 3.

The three binary sequences x₀(i), x₁(i), and x₂(i) may be determined based on recurrence equations ‘x₀(i+6)=[x₀(i+1) 30 x₀(i)]₂’, ‘x₁(i+6)=[x₀(i+5)+x₀(i+2)+x₀(i+1)+x₀(i)]₂’ and ‘x₂(i+3)=[x₀(i+2)+x₀(i)]₂’, respectively. A modulo-2 operation in each recurrence equation may be the same as or similar to an XOR operation. For example, the modulo-2 operation of each recurrence equation may correspond to an XOR operation in an LFSR.

The identification index c may be determined based on a function ‘c=3g+u’ with g and u as input variables. Here, g may correspond to a cell group identity (CGI), and u may correspond to a physical identity (PID). The numbers shown in Equation 2 are merely examples for convenience of description, and the second exemplary embodiment of the radio signal generation method is not limited thereto.

In Equation 2, a calculation formula ‘θ_{c}(m)=[x₀([m+m₀]₆₃)+x₁([m+m₁]₆₃)+x₂([m+m₂]₇)]₂’ for calculating the initial base sequence θ_{c}(m) based on three binary sequences x₀(i), x₁(i), and x₂(i) may correspond to an element-wise modulo-2 sum operation on three different binary sequences.

Meanwhile, the intermediate base sequences may be composed of first intermediate base sequences b_{c}(m) and second intermediate base sequences \tilde{b}_{c}(m). Here, the first intermediate base sequence b_{c}(m) may be generated by one initial base sequence θ_{c}(m). For example, as shown in Equation 2, the first intermediate base sequence may be generated as 1−2θ_{c}(m). Here, the first intermediate base sequence may be a second-first intermediate sequence. Then, the second intermediate base sequence \tilde{b}_{c}(m) may be generated by one initial base sequence θ_{c}(m). For example, as in Equation 2, the second intermediate base sequence may be generated as −(1−2θ_{c}(m))=−1+2θ_{c}(m). The second intermediate base sequence may be a second-second intermediate sequence. The second intermediate base sequence may be generated from the first intermediate base sequence, and may be generated by multiplying the first intermediate base sequence by a negative number. In other words, the second intermediate base sequence \tilde{b}_{c}(m) may be −b_{c}(m). In this regard, the second intermediate base sequence may be referred to as a modified first intermediate base sequence.

In Equation 2, a calculation equation ‘b_{c}(m)=1−2θ_{c}(m)’, which calculates the first intermediate base sequence b_{c}(m) based on one initial base sequence, may correspond to a BPSK operation. The first intermediate base sequence b_{c}(m) may have real numbers each being 1 or −1. The first intermediate base sequence may be a Kasami base sequence.

Meanwhile, the final base sequences S_{c}(m) may be generated based on the first intermediate base sequences and the second intermediate base sequences. In this case, when m is an even number, the final base sequences S_{c}(m) may be generated based on the first intermediate base sequences. In contrast, when m is an odd number, the final base sequences S_{c}(m) may be generated based on the second intermediate base sequences. However, when m is M, the final base sequence S_{c}(m) may be 0. As described above, the final base sequences may be generated by distributed concatenation of the first intermediate base sequences and the second intermediate base sequences.

Referring to FIG. 6, the final base sequences S_{c}(m) may be transmitted using 2(M+1) subcarriers among N input subcarriers in the frequency domain. In this case, when m is an even number, the first intermediate base sequences may be sequentially assigned to the final base sequences S_{c}(m). In contrast, when m is an odd number, the second intermediate base sequences may be sequentially assigned to the final base sequences S_{c}(m). However, S_{c}(M) when m is M may be 0.

In an exemplary embodiment of the communication system, the value of the identification index c may be selected between 0 and Ξ−1. Ξ may mean the number of distinguishable identification index c values.

Referring again to FIG. 7, FIG. 7 shows the final base sequence S_{c}(m) generated based on Equation 2 in the second exemplary embodiment of the radio signal generation method, or an exemplary embodiment 710 of constellation of the first radio signal (hereinafter, basic constellation) generated based on the final base sequence S_{c}(m). The first radio signal may be expressed as two constellation points on the basic constellation 710. The two constellation points corresponding to the first radio signal may both have a real number 1 or −1.

The final base sequence S_{c}(m) may use the same or almost the same frequency resource as the frequency resource of the cell identification synchronization signal used to transmit the NR base sequence. Additionally, the final base sequence S_{c}(m) can theoretically have a total number of identification indices 1.5 times greater than the total number of identification indices of NR, despite hardware impairment.

Meanwhile, Ξ may mean the total number of PCIs, and may be defined as Ξ=10081 (1≤ι≤[63/(3K)]). The proposed cell identification signal may be generated by an element-wise modulo-2 sum operation of a length-63 m-sequence x₀, a length-63 m-sequence x₁ obtained by decimating x₀ by 17, and a length-7 m-sequence x₂ obtained by decimating x₀ by 9. The second intermediate base sequence \tilde{b}_{c}(m) applied in Equation 2 may be a sequence with a opposite polarity (negating) to the first intermediate base sequence. However, it is not limited thereto, and all possible modified sequences of the first intermediate base sequence may be applied as the second intermediate base sequence \tilde{b}_{c}(m).

In Equation 2, K may be set to 5 as in the NR system. Then, the maximum Ξ may become 4032, theoretically allowing 1.5 times more PCIs to be distinguished than the 5G NR system. In addition, as shown in Equation 1, distributed concatenation is performed between the first intermediate base sequence and the second intermediate base sequence, so that it can be robust against hardware impairments even when performing PCI detection in the frequency domain.

FIG. 8 is a flowchart illustrating a first exemplary embodiment of a method for detecting cell identification information in a communication system.

Referring to FIG. 8, a second communication node may generate final base sequences using a method according to the second exemplary embodiment of the radio signal generation method (S800). In this case, the second communication node may classify the final base sequences respectively corresponding to physical identifiers, and generate final base sequence groups (S801).

Meanwhile, a first communication node may transmit a first signal consisting of a PSS and an SSS including the final base sequence S_{c}(m) to the second communication node in the time domain. Accordingly, the second communication node may receive the first signal consisting of the PSS and the SSS including the final base sequences from the first communication node (S802).

The second communication node may detect the PSS and SSS from the first signal received from the first communication node (S803). The second communication node may detect a physical identity from the detected PSS (S804). Thereafter, the second communication node may calculate a correlation value between the SSS and each of the final base sequences included in the final base sequence group corresponding to the detected physical identity (S805). Then, the second communication node may obtain a physical cell identity corresponding to a final base sequence with the maximum correlation value (S806).

Alternatively, the second communication node may generate the final base sequences using the method according to the second exemplary embodiment of the radio signal generation method. The first communication node may transmit a first signal consisting of an SSS including the final base sequence S_{c}(m) to the second communication node in the time domain. Accordingly, the second communication node may receive the first signal composed of the SSS including the final base sequences from the first communication node.

The second communication node may detect the SSS from the first signal received from the first communication node. The second communication node may calculate a correlation value between the SSS and each of the final base sequences. Then, the second communication node may obtain a physical cell identity corresponding to a final base sequence with the maximum correlation value.

Meanwhile, the final base sequence S_{c}(m) may be transmitted from the first communication node as being transformed into a time domain signal. Accordingly, the second communication node may receive the signal including the final base sequences from the first communication node. In this case, the second communication node may remove interference components coming from adjacent cells from the received time domain signal. Then, the second communication node may transform the received signal into a frequency domain signal R_{c}(k) as shown in Equation 3 below.

$${R}_{c} ( k ) = {\sum }_{m} {\sum }_{v} \{ {C}_{{[ k - m ]}_{N}} {P}_{{[ m - v ]}_{N}} H ( v ) {S}_{c ( v )} \} + Z ( k ) , \qquad [ Equation 3 ]$$

$${C}_{i} = \frac{1 - {e}^{j 2 πϵ}}{1 - {e}^{- j \frac{2 π ( i - ϵ )}{N}}} ,$$

$${P}_{i} = \frac{1}{N} {\sum }_{n} {e}^{j {φ}_{c}^{5} ( n )} {e}^{- j \frac{2 π ni}{N}} .$$

Here, Cᵢ may mean a frequency domain coefficient corresponding to a fractional carrier frequency offset (CFO) ϵ in a range of −0.5≤ϵ≤ 0.5, Pᵢ may mean a phase noise (PhN) component, and H(v) and Z(k) may mean a frequency response coefficient and a noise of the channel, respectively. In Equation 3, assuming that the factors affecting a subcarrier k as inter-carrier interference (ICI) components are (2k_{ϵ}+1) frequency-domain CFO components in a range of [symbol] {k−k_{ϵ}, k−k_{ϵ}+1, . . . , k+k_{ϵ}} and (2k_{φ}+1) frequency-domain phase noise components in a range of [symbol] {k−k_{φ}, k−k_{φ}+1, . . . , k+k_{φ}}, Equation 3 may be expressed as Equation 4.

R_{c}(k)=C₀P₀H(k)S_{c}(k)+ [symbol] {C_{[k-m]}_{_{N}}P_{[m-v]}_{_{N}}H(v)S_{c(v)}}+ [symbol] {C_{[k-m]}_{_{N}}P_{[m-v]}_{_{N}}H(v)S_{c(v)}}+Z(k). [Equation 4]

Here, A×B and A\B may represent a Cartesian product of two sets A and B and a difference between two sets A and B, respectively. The first term in Equation 4 may correspond to a transmission signal of the subcarrier k affected by a common phase error and the CFO, and the second term in Equation 4 may correspond to a dominant ICI component. The third term in Equation 4 may correspond to a negligible ICI component.

In the frequency domain, PCI detection performance using the proposed cell identification signal may mainly depend on a cross-correlation distribution. A cross-correlation output [symbol] (c′) of a frequency-domain cell identification signal S_{c′}(k) in Equation 2 corresponding to R_{c}(k) and PCI hypothesis c′ϵ{0, . . , Ξ−1} described above may be expressed as Equation 5 below.

$$( {c}^{′} ) = {\vert {\sum }_{k = 0}^{2 M} {{S}_{{c}^{′}} ( k )}^{H} {R}_{c} ( k ) \vert}^{2} . \qquad [ Equation 5 ]$$

For example, assuming k_{ϵ}=1, k_{φ}=0, H(k)=1, and Z(k)=0, three frequency-domain CFO components in a range of ={k−1, k, k+1} and three frequency-domain phase noise components i in a range of [symbol] ={k−1, k, k+1} may affect the characteristics of the sequence. Here, a frequency-domain phase noise coefficient Pᵢ may be defined as Pᵢ=δ(i). In this case, [symbol] (c′) may be approximated as in Equation 6 below.

[symbol]

(c′)≈|C₀Σₖ₌₀^{2M}S_{c′}(k)^{H}S_{c}(k)+C₁Σₖ₌₀^{2M}S_{c′}(k)^{H}S_{c}(k−1)+C_{N-1}Σₖ₌₀^{2M}S_{c′}(k)^{H}S_{c}(k+10|²| [Equation 6]

A normalized cross-correlation (NCC) value may represent a sidelobe value of a cross-correlation value [symbol] (c′) for a case when c≠c′ which is normalized by a cross-correlation value [symbol] (c) at the peak.

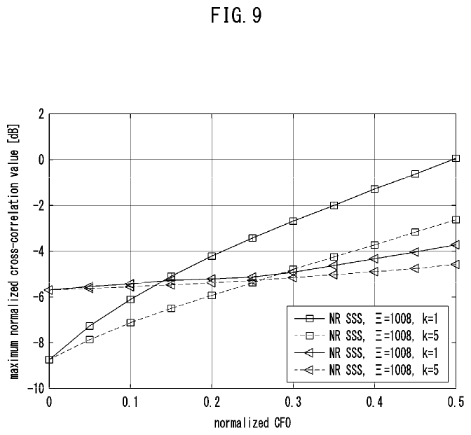

FIG. 9 is a graph illustrating maximum normalized cross-correlation values of a cell identification signal for NR and a proposed cell identification signal according to a normalized carrier frequency offset.

Referring to FIG. 9, under an assumption that k_{ϵ}=1, k_{φ}=0, H(k)=1, and Z(k)=0, maximum NCC values between the NR SSS and the proposed cell identification signal (i.e. ‘BR SSS’) according to various normalized CFOs are illustrated. When K=1, the maximum NCC value of the NR SSS may be about 0 dB at ϵ=0.5. In this case, [symbol] (c′) of a PCI c′≠c such that S_{c′}(k)=S_{c}(k−1) may be the same as a cross-correlation value [symbol] (c) at the peak.

As the normalized CFO increases, the sidelobes may increase with C₁. On the other hand, [symbol] (c) may decrease with C₀. Additionally, ϵ=1 as an integer CFO may cause a cyclic shift in the frequency domain. Accordingly, a false alarm may occur. Therefore, the 5G NR specifies K=5.

As shown in FIG. 9, the maximum normalized cross-correlation value when K=5 compared to K=1 may have a maximum NCC value lower than 2.6 dB. Meanwhile, a cross-correlation output of the frequency domain cell identification signal proposed based on distributed concatenation may be define with respect to the base sequence b_{c}. Then, [symbol] (c′) may be expressed as Equation 7 below.

[symbol]

(c′)≈|(2C₀−C_{N-1}−C₁)Σₘ₌₀^{M-1}b_{c′}(m)^{H}b_{c}(m)−C₁Σₘ₌₀^{M-1}b_{c′}(m)^{H}b_{c}(m−1)−C_{N-1}Σₘ₌₀^{M-1}b_{c′}(m)^{H}b_{c}(m+1)|². [Equation 7]

As shown in Equation 7, the peak term of the cross-correlation output of the NR SSS may only be affected by C₀. The peak term may be significantly reduced as the normalized CFO increases.

However, as shown in Equation 7, the peak term of the cross-correlation output of the proposed cell identification signal (BR SSS) may be scaled by a coefficient (2C₀−C_{N-1}−C₁). The three dominant components within the coefficient may be constructively combined in various normalized CFO environments. This may be a basis for the robustness against normalized CFOs compared to the NR SSS. In other words, the distributed concatenation between the base sequence and the modified sequence of the proposed cell identification signal allows the concatenated sequence to have a high diversity order, which can lead to robust and excellent PCI detection even at high fractional CFOs. When K=1, the BR SSS may have a lower maximum NCC value of 3.7 dB at ϵ=0.5 compared to the NR SSS. Even when K=5, the BR SSS may have a lower maximum NCC value of 2.0 dB at ϵ=0.5 compared to the NR SSS. Table 4 may show the theoretical maximum numbers of PCIs according to K=1 and K=5.

TABLE 4

| | Maximum number of PCIs | Maximum number of PCIs |
|---|---|---|
| | at K = 1 | at K = 5 |
| NR SSS | 126 × 112 = 14112 | 24 × 112 = 2688 |
| BR SSS | 63 × 48 × 7 = 21168 | 12 × 48 × 7 = 4032 |

For comparison with the NR SSS, m₀ in Equation 2 may be a function of a PID u. Accordingly, the number of distinct m₀ may be a multiple of 3. A cardinality of a set of cyclically distinct sequences may be assumed to be a multiple of 112. Under these assumptions, the proposed cell identification signal may distinguish up to 1.5 times more PCI than the NR SSS under the same condition.

Meanwhile, through various performance evaluations, it can be seen that the proposed cell identification signal (i.e. ‘BR SSS’) can be more robust to hardware impairment than the NR SSS during PCI detection. To this end, the PCI detection performances of the BR SSS and the NR PSS may be compared under various performance evaluation conditions. In this case, the performance evaluation conditions may be as follows.
The antenna configuration may be 1×2. Performance evaluation may apply an equal gain combining receive diversity technique.
The size N of IFFT may be 256.
A carrier frequency may be 70 GHz.
A radio channel model used for evaluation may be a tapped delay line A (TDL-A) (for NLOS evaluation) and a TDL-D (for LoS evaluation) recommended by 3 the GPP.
A moving speed of the terminal may be 3 km/h.
An unnormalized residual CFO \tilde{ϵ} may be 7 Hz (corresponding to 0.1 ppm).
A normalized phase noise linewidth β0 may be 0.1 or 0.4.
A root mean square (RMS) delay spread may be 16 ns.
A subcarrier spacing (SCS) η may be 120 kHz or 480 KHz.
The performance evaluation may be performed on two cells. Here, one may be considered as a serving cell and the other may be considered as an adjacent cell.
A signal to interference ratio (SIR) may be set to 9 dB.
The maximum number Ξ of PCIs may be 1008, 2688, or 4032.

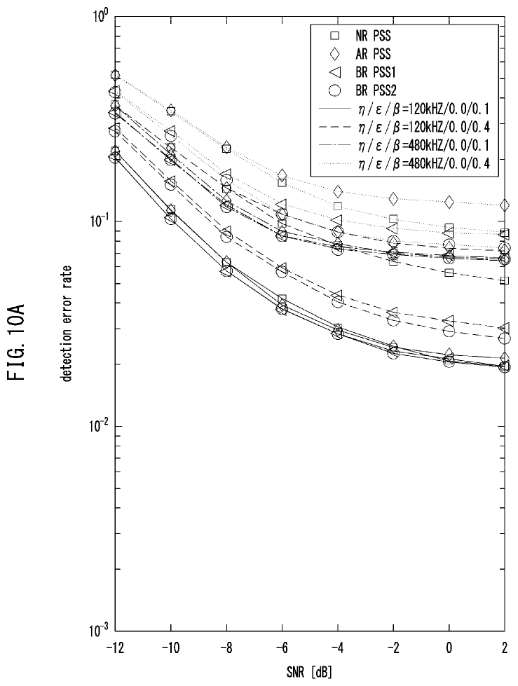

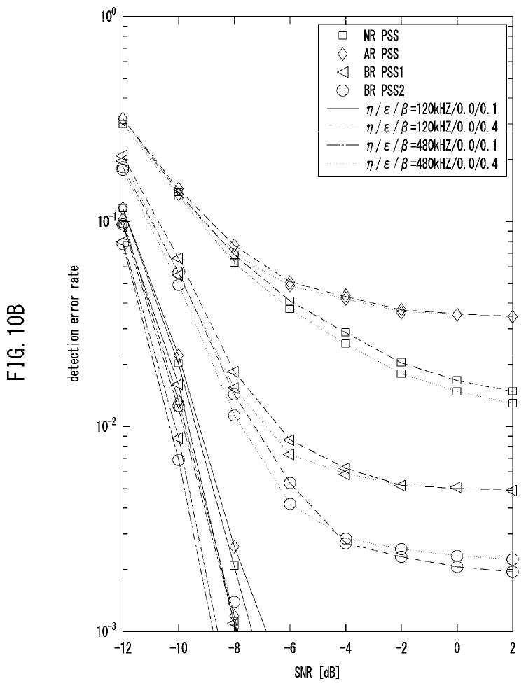

FIG. 10A is a graph illustrating performance of a detection error rate of an SSS of TDL-A, and FIG. 10B is a graph illustrating performance of a detection error rate of an SSB of TDL-D.

Referring to FIGS. 10A and 10B, as the maximum number Ξ of PCIs increases, the number of PCI hypotheses close to the peak cross-correlation output value may increase. Therefore, signal to noise ratio (SNR) shifts may occur in both the NR SSS and the BR SSS. A detection error rate (DER) of the NR SSS with Ξ=2688 may be compared to the NR SSS with the baseline Ξ=1008 at given η and β. Here, the SNR may be shifted from 0.35 dB to 2 dB.

The DER of the BR SSS with Ξ=4032 may be compared to the NR SSS with the baseline Ξ=1008 at given η and β. In this case, the SNR may shift from 0.5 dB to 3 dB. As a phase distortion due to frequency selectivity and phase noise worsens, the amount of SNR shift may generally increase.

Meanwhile, in the case of the TDL-D channel environment, the baseline Ξ=1008 may be applied at the same given η and β. In this case, the BR SSS may achieve a lower DER than the NR SSS. In particular, the BR SSS may have a steeper DER slope than the NR SSS at high SNR. This may mean that the BR SSS has a higher diversity order than the NR SSS in a high phase noise environment. A difference in the DER slope between the BR SSS and the NR SSS may increase as β increases.

In case of a relatively high phase noise of β=0.4, the BR SSS with η=480 kHz may achieve a DER of about 10⁻² at SNR=−10 dB, shifted by −6 dB compared to the NR SSS with η=480 kHz. A phase noise environment with η=120 kHz and β=0.4 may have the same level of cross-sectional power spectral density as a phase noise environment with η=480 kHz and β=0.1. The DER performances of the BR SSS and the NR SSS at η=480 kHz may be significantly improved at high SNR due to the reduction of ICI.

Both the BR SSS and the NR SSS can provide higher DER performance in TDL-A than TDL-D because they suffer from frequency selectivity despite a short delay spread due to a large SCS. The NR SSS with η=120 kHz may provide the lowest DER in the TDL-A channel for β=0.1, where frequency selectivity dominantly affects sequence characteristics over phase noise. However, in the case of β=0.4, where phase noise dominates sequence characteristics, the BR SSS, which has robust ICI characteristics, can provide a lower DER than the NR SSS.

On the other hand, when comparing the NR SSS for η=120 kHz and β=0.4 with the NR SSS for η=480 kHz and β=0.1, the NR SSS with a larger SCS may provide a higher DER at low SNR. However, the NR SSS with a larger SCS may provide a lower DER at high SNR.

Since the applied PCI detection algorithm is based on a non-coherent method, there may be some kind of trade-off between reducing ICI and increasing frequency selectivity. However, the BR SSS can always achieve better DER performance compared to the NR SSS for a lower SCS due to its robustness against hardware impairment. Accordingly, the BR SSS with η=120 KHz can achieve lower DER performance compared to the NR SSS under frequency-selective fading environment with high phase noises. According to the performance evaluation of the present disclosure, the BR SSS of Ξ=1008 and Ξ=4032 achieves a DER of about 10⁻² at SNR=−4 dB and −2 dB, respectively, while the NR SSS of Ξ=1008 achieves the same DER performance of about 10⁻² at SNR=2 dB.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

### STATEMENT REGARDING PRIOR DISCLOSURES BY THE INVENTOR OR A JOINT INVENTOR

The inventors of the present application have made related disclosure in Kapseok CHANG et al., “Synchronization Under Hardware Impairments in Over-6-GHz Wireless Industrial IoT Systems,” IEEE Internet of Things Journal, Nov. 16, 2022. The related disclosure was made less than one year before the effective filing date (Nov. 29, 2022) of the present application and the inventors of the present application are the same as those of the related disclosure. Accordingly, the related disclosure is disqualified as prior art under 35 USC 102(a)(1) against the present application. See 35 USC 102(b)(1)(A).

What is claimed is:

1. A method of a first communication node, comprising:
generating a first intermediate base sequence consisting of M elements based on first, second and third binary sequences, wherein M is a natural number;
generating a second intermediate base sequence consisting of M elements by modifying the first intermediate base sequence;
generating a base sequence consisting of 2M elements based on distributed concatenation of the first intermediate base sequence and the second intermediate base sequence;
mapping modulation symbols generated by modulating the base sequence to 2 (M+1) subcarriers; and
transmitting a signal consisting of the mapped modulation symbols to a second communication node.

2. The method according to claim 1, wherein the generating of the first intermediate base sequence comprises:
generating an initial base sequence by performing an element-wise modulo-2 sum operation on the first, second, and third binary sequences; and
generating the first intermediate base sequence by performing a binary phase shift keying (BPSK) operation on the initial base sequence.

3. The method according to claim 1, wherein the first binary sequence is a first m-sequence with a length of 63, the second binary sequence is a second m-sequence with a length of 63 obtained by decimating the first binary sequence by 17, and the third binary sequence is a third m-sequence with a length of 7 obtained by decimating the first binary sequence by 9.

4. The method according to claim 1, wherein the first binary sequence is generated based on a first generator polynomial having a maximum degree (n+1) and a first identifier for the first communication node, the second binary sequence is generated based on a second generator polynomial having a maximum degree (n+1) and the first identifier for the first communication node, the third binary sequence is generated based on a third generator polynomial having a maximum degree (n/2+1) and the first identifier for the first communication node, and n is a natural number.

5. The method according to claim 1, wherein the second intermediate base sequence is a sequence whose polarity is opposite to a polarity of the first intermediate base sequence.

6. A method of a second communication node, comprising:
receiving, from a first communication node, a signal consisting of modulation symbols generated by modulating a base sequence associated with a physical cell identity of the first communication node; and
obtaining the physical cell identity of the first communication node from the signal using base sequences associated with physical cell identities,
wherein each of the base sequences associated with the physical cell identities is generated, for each of the physical cell identities, as 2M elements based on distributed concatenation of a first intermediate base sequence consisting of M elements generated based on first, second, and third binary sequences and a second intermediate base sequence consisting of M elements generated by modifying the first intermediate base sequence, and M is a natural number.

7. The method according to claim 6, wherein the obtaining of the physical cell identity of the first communication node comprises:
detecting the modulation symbols from the signal;
calculating correlation values between the modulation symbols and the base sequences;
identifying a physical cell identity of a base sequence with a maximum correlation value; and
obtaining the identified physical cell identity as the physical cell identity of the first communication node.

8. The method according to claim 6, further comprising, when the signal includes a primary synchronization signal (PSS), obtaining the physical cell identity of the first communication node from the signal using the base sequences associated with the physical cell identities;
obtaining the PSS from the signal;
identifying a physical identity from the obtained PSS;
detecting the modulation symbols from the signal;
calculating correlation values between the modulation symbols and base sequences associated with the identified physical identity;
identifying a physical cell identity of a base sequence with a maximum correlation value; and
obtaining the identified physical cell identity as the physical cell identity of the first communication node.

9. A first communication node in a communication system, comprising a processor, wherein the processor causes the first communication to perform:
generating a first intermediate base sequence consisting of M elements based on first, second and third binary sequences, wherein M is a natural number;
generating a second intermediate base sequence consisting of M elements by modifying the first intermediate base sequence;
generating a base sequence consisting of 2M elements based on distributed concatenation of the first intermediate base sequence and the second intermediate base sequence;
mapping modulation symbols generated by modulating the base sequence to 2 (M+1) subcarriers; and
transmitting a signal consisting of the mapped modulation symbols to a second communication node.

10. The first communication node according to claim 9, wherein in the generating of the first intermediate base sequence, the processor further causes the first communication to perform:
generating an initial base sequence by performing an element-wise modulo-2 sum operation on the first, second, and third binary sequences; and
generating the first intermediate base sequence by performing a binary phase shift keying (BPSK) operation on the initial base sequence.

11. The first communication node according to claim 9, wherein the first binary sequence is a first m-sequence with a length of 63, the second binary sequence is a second m-sequence with a length of 63 obtained by decimating the first binary sequence by 17, and the third binary sequence is a third m-sequence with a length of 7 obtained by decimating the first binary sequence by 9.

12. The first communication node according to claim 9, wherein the first binary sequence is generated based on a first generator polynomial having a maximum degree (n+1) and a first identifier for the first communication node, the second binary sequence is generated based on a second generator polynomial having a maximum degree (n+1) and the first identifier for the first communication node, the third binary sequence is generated based on a third generator polynomial having a maximum degree (n/2+1) and the first identifier for the first communication node, and n is a natural number.

13. The first communication node according to claim 9, wherein the second intermediate base sequence is a sequence whose polarity is opposite to a polarity of the first intermediate base sequence.
